(19) United States
(12) Patent Application Publication
(10) Pub. No.: US 2025/0387704 A1
(43) Pub. Date: Dec. 25, 2025

(54) INFORMATION PROCESSING SYSTEM, STORAGE MEDIUM, AND INFORMATION PROCESSING METHOD

(71) Applicant: NINTENDO CO., LTD., Kyoto (JP)

(72) Inventor: Shinobu SUZUKI, Kyoto (JP)

(21) Appl. No.: 19/242,202

(22) Filed: Jun. 18, 2025

(30) Foreign Application Priority Data
Jun. 19, 2024 (JP) 2024-098758

(51) Int. Cl. A63F 13/52

(52) U.S. Cl. CPC A63F 13/52

(57) ABSTRACT

An example of a host device receives, from an example of a guest device, first operation data indicating an operation on the guest device, and executes a game process based on the first operation data. The host device generates a game image indicating results of the game process, and transmits the generated game image to the guest device. The guest device receives the game image transmitted from the host device, and starts a process of rendering the received game image at a timing that is a predetermined amount of time before or after a timing for switching display of the game image. The guest device acquires the first operation data, and transmits the first operation data to the host device.

### CROSS REFERENCE TO RELATED APPLICATION

This application claims priority to Japanese Patent Application No. 2024-098758, filed on Jun. 19, 2024, the entire contents of which are incorporated herein by reference.

### FIELD

The present disclosure relates to an information processing system, a storage medium, and an information processing method for executing a game in which communication is performed between information processing devices.

### BACKGROUND AND SUMMARY

There has been a technology for executing a game in which communication is performed between information processing devices. There has also been a countermeasure technology for delays that occur in communication between information processing devices during a game.

There is a demand for a novel countermeasure technology for communication delays.

The present application discloses an information processing system, a storage medium, and an information processing method capable of providing a new countermeasure against communication delays.

### (Configuration 1)

An example of an information processing system comprises a host device and one or more guest device capable of communicating with the host device. The host device comprises: one or more memories storing a first set of instructions; and one or more processors that execute the first set of instructions. The one or more processors and the first set of instructions are configured to collaboratively perform a first set of operations comprising: receiving, from the guest device, first operation data indicating an operation on the guest device; executing a game process based on the first operation data; generating a game image indicating results of the game process; and transmitting the generated game image to the guest device. The guest device comprises: one or more memories storing a second set of instructions; and one or more processors that execute the second set of instructions. The one or more processors and the second set of instructions are configured to collaboratively perform a second set of operations comprising: receiving the game image transmitted from the host device; starting a process of rendering the received game image at a timing that is an amount of time before or after a timing for switching display of the game image; acquiring the first operation data; and transmitting the first operation data to the host device.

With configuration (1) above, by setting the second cycle shorter than the first cycle, it is possible to reduce the communication traffic between the host device and the guest devices. Therefore, it is possible to reduce the possibility of delays, and to realize a novel delay countermeasure process.

### (Configuration 2)

In the configuration of the above (1), the first set of operations may further comprise: acquiring second operation data indicating an operation on the host device; executing the game process based on the first operation data and the second operation data; outputting the game image indicating the results of the game process on a display device of the host device.

With configuration (2) above, since the game image is displayed in the second cycle on the host device, it is possible to possible to display a smoother game image.

### (Configuration 3)

In the configuration of the above (1) or (2), the timing to start rendering the game image may be a predetermined amount of time before the display switching timing. The predetermined amount of time may be an amount of time determined in consideration of an amount of time required for rendering the game image.

With configuration (3) above, it is possible to increase the possibility that a game image received in a certain frame on the guest device can be rendered within that frame.

### (Configuration 4)

In the configuration of the any one of above (1) to (3), the first set of instructions may be configured to be included in a game program for the game process or system software different from the game program. The system software may include: an instruction to, when receiving the generated game image from the game program, perform the transmission of the generated game image to the guest device; and an instruction to perform the receiving the second operation data from the guest device to pass the second operation data to the game program.

With configuration (4) above, it is possible to increase the possibility that a game image received in a certain frame on the guest device can be rendered within that frame.

### (Configuration 5)

In the configuration of the any one of above (1) to (4), the first set of operations may further comprise: reducing a resolution of the generated game image; and transmitting the game image whose resolution has been reduced to the guest device.

With configuration (5) above, the game image is displayed also on the host device.

### (Configuration 6)

In the configuration of the any one of above (1) to (5), the first set of operations may further comprise: starting rendering the game image at a timing for switching the game image to be displayed on the host device.

With configuration (6) above, it is possible to increase the possibility that a game image received in a certain frame on the guest device can be rendered within that frame.

### (Configuration 7)

In the configuration of the any one of above (1) to (6), the timing for switching the game image to be displayed on the host device and the timing for switching the game image to be displayed on the guest device may be independent of each other.

With configuration (7) above, it is no longer necessary to create the function of transmitting the image data to the guest device and the function of receiving the operation data from the guest device for each game program, thereby improving the efficiency in game program development. Since there is no need to store the game program on the guest device for the game, it is possible to improve user convenience.

The present specification discloses an example of a computer-readable storage medium storing an information processing program for executing the processes described in (1) to (7) above on a computer of an information processing device. The present specification also discloses an example of a computer-readable storage medium storing an information processing program for executing some of the processes described in (1) to (7) above (e.g., some of the processes to be executed on the host device to be described later, or some of the processes to be executed by the host program and/or guest program to be described later) on a computer of an information processing device. The present specification also discloses an example of an information processing method for executing the processes described in (1) to (7) above on an information processing system. The present specification also discloses an example of an information processing device (e.g., a host device or a guest device) included in the information processing system described in (1) to (7) above.

These and other features, aspects, and advantages of the subject matter described herein will become more apparent from the following detailed description when taken in conjunction with the accompanying drawings.

### BRIEF DESCRIPTION OF THE DRAWINGS

FIG. 1 is a block diagram showing an example of a configuration of a non-limiting information processing system according to the present embodiment;

FIG. 2 is a block diagram showing an example of a hardware configuration of a non-limiting information processing device;

FIG. 3 is a functional block diagram showing an example of functions of a non-limiting host device and guest device;

FIG. 4 is a diagram showing an example of a flow until the game process using operation data acquired by a non-limiting host device is executed;

FIG. 5 is a diagram showing an example of operation data stored in a non-limiting host device in a particular frame;

FIG. 6 is a diagram showing another example of operation data stored in a non-limiting host device in a certain frame;

FIG. 7 is a diagram showing an example of the relationship between a rendering process and a game image used therein;

FIG. 8 is a diagram showing an example of various data used for information processes in a non-limiting host device;

FIG. 9 is a diagram showing an example of various data used for information processes in a non-limiting guest device;

FIG. 10 is a flow chart showing an example of a flow of an information process executed by a non-limiting game program on a CPU of a non-limiting host device;

FIG. 11 is a flow chart showing an example of a flow of an information process executed by a non-limiting game program on a CPU of a non-limiting host device;

FIG. 12 is a flow chart showing an example of a flow of a graphic process executed by a non-limiting game program on a GPU of a non-limiting host device;

FIG. 13 is a flow chart showing an example of a flow of an information process executed by a non-limiting host program on a CPU of a non-limiting host device;

FIG. 14 is a flow chart showing an example of a flow of a reception process executed by a non-limiting guest program on a CPU of a non-limiting guest device; and

FIG. 15 is a flow chart showing an example of a flow of a rendering/transmitting process executed by a non-limiting guest program on a CPU of a non-limiting guest device.

### DETAILED DESCRIPTION OF NON-LIMITING EXAMPLE EMBODIMENTS

### [1. Hardware Configuration of Information Processing System]

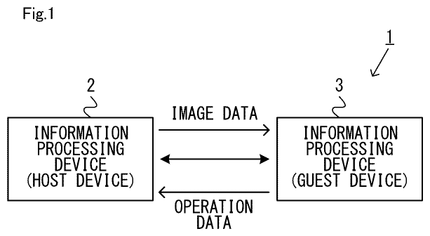

An information processing system according to an example of the present embodiment will now be described. FIG. 1 is a block diagram showing an example of a configuration of an information processing system according to the present embodiment. As shown in FIG. 1, an information processing system 1 includes a plurality of information processing devices (in FIG. 1, two information processing devices 2 and 3). The number of information processing devices included in the information processing system 1 may be any number of two or more. The information processing devices 2 and 3 may each be any type of information processing device, such as a game machine, smartphone, tablet terminal, or personal computer, for example, regardless of whether they are portable or stationary. The information processing devices 2 and 3 may be of different types or of the same type.

The information processing devices 2 and 3 can communicate with each other. In the information processing system 1, the game is executed while the information processing devices 2 and 3 exchange data for the game process via communication. In the present embodiment, among the information processing devices included in the information processing system, the information processing device that has a game program stored therein or is authorized to execute the game program (in the example shown in FIG. 1, the information processing device 2) operates as a host device, and the other information processing devices (in the example shown in FIG. 1, the information processing devices 3) operate as guest devices. In the present embodiment, each information processing device becomes a host device or a guest device depending on the situation. The host device is an information processing device that executes the game process based on the game program to generate game images indicating the results of the game process. The generated game images are transmitted from the host device to the guest device. The guest device is an information processing device that does not need to execute the game process based on the game program, and receives game images from the host device. The guest device transmits operation data indicating user operations thereon to the host device, and the host device executes the game process based on the operation data. Note that communication between the information processing devices 2 and 3 may be performed by any means of communication, such as Internet communication or short-range wireless communication, and may be performed directly between the devices or via another device (e.g., a server).

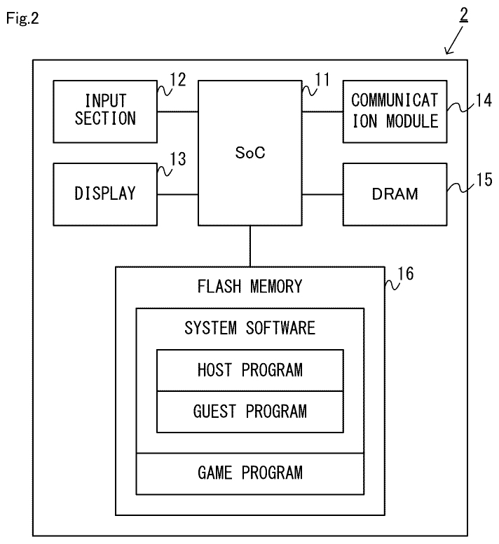

FIG. 2 is a block diagram showing an example of the hardware configuration of the information processing device 2. Note that it is assumed in the present embodiment that the information processing device 2 and the information processing device 3 are of the same type, and the information processing device 3 has the same configuration as the information processing device 2, although not shown in the figures. In the present embodiment, each of the information processing devices 2 and 3 has both the function of operating as a host device and the function of operating as a guest device. Note that in the present embodiment, an information processing device that has system software to be described below, an OS, etc., operates as a host device by executing the game program. On the other hand, the information processing device can operate as a guest device even if it does not store the game program. Note however that in other embodiments, the information processing device may be operable as a guest device by executing the game program. Note that in other embodiments, the information processing device included in the information processing system 1 may be configured to have only one of the function of operating as a host device and the function of operating as a guest device. That is, in other embodiments, the information processing system 1 may have a configuration including an information processing device that can operate only as a host device and an information processing device that can operate only as a guest device.

As shown in FIG. 2, the information processing device 2 includes an SoC (System-on-a-chip) 11 that has a processor and memory for executing information processes for the game. For example, the SoC 11 includes processors such as a CPU (Central Processing Unit) and a GPU (Graphics Processing Unit). The SoC 11 is connected to the elements 12 to 16 shown in FIG. 2. The processes of the present embodiment may be executed by multiple processors. For example, the processes may be executed by multiple processors at remote locations, such as some processes being executed by a processor of a server.

The information processing device 2 includes an input section 12. The input section 12 detects an operation performed by a user on the information processing device 2 and outputs operation data indicating the detected operation. The input section 12 may include, for example, operation members such as an analog stick and buttons, and may include sensors such as a gyro sensor and an acceleration sensor. Note that in other embodiments, the information processing device 2 may acquire operation data from the controller that has an input section and is capable of communicating with the information processing device 2 via short-range wireless communication such as Wi-Fi (registered trademark) or Bluetooth (registered trademark), or in some cases via the Internet.

The information processing device 2 includes a display 13 for displaying images. Note that in other embodiments, the information processing device 2 does not need to include the display 13, and may instead display images on a display device capable of communicating with the information processing device 2.

The information processing device 2 includes a communication module 14 for communicating with other information processing devices. In the present embodiment, the communication module 14 is capable of performing Internet communication as the first communication mode and is also capable of performing local communication as the second communication mode. The first communication mode is a mode in which the information processing device connects to the Internet by connecting to a wireless LAN using a method compliant with the Wi-Fi standard, for example, and communicates with other information processing devices connected to the Internet (no matter whether communication is performed via a server or directly). The second communication mode is a mode in which the information processing device performs direct wireless communication by short-range wireless communication with other information processing devices that exist within the communication range thereof by a predetermined communication method (e.g., a communication method using a proprietary protocol or a method compliant with the Wi-Fi standard). Note that there is no limitation on the communication method between the information processing devices included in the information processing system, and it may be wired communication or wireless communication.

The information processing device 2 includes a DRAM 15 and a flash memory 16 as examples of storage sections. The DRAM 15 is used for information processes for executing the game (e.g., the game process for advancing the game, the process for transmitting and receiving data with other information processing devices for the game, etc.) and for storing various data generated by the information processes. The flash memory 16 stores various programs for the processor of the information processing device 2 to execute the information processes for executing the game.

In the present embodiment, the flash memory 16 stores a game program and system software different from the game program. The game program is stored in the flash memory 16 by downloading from a predetermined server (in some cases, it may be pre-installed). Note that the game program may be stored on a storage medium (e.g., a memory card) that can be attached to and detached from the information processing device 2. In the present embodiment, the system software refers to a program that is installed in advance on the information processing device 2 regardless of whether there has been an instruction by the user. The system software includes a host program that is executed when the information processing device 2 operates as a host device, and a guest program that is executed when the information processing device 2 operates as a guest device. Note that the information processing device 2 can store multiple game programs and execute different games by executing the game programs. The host program and the guest program are programs that are shared by game programs (i.e., they are used in common when the game programs are executed).

### [2. Overview of Operations in Information Processing System]

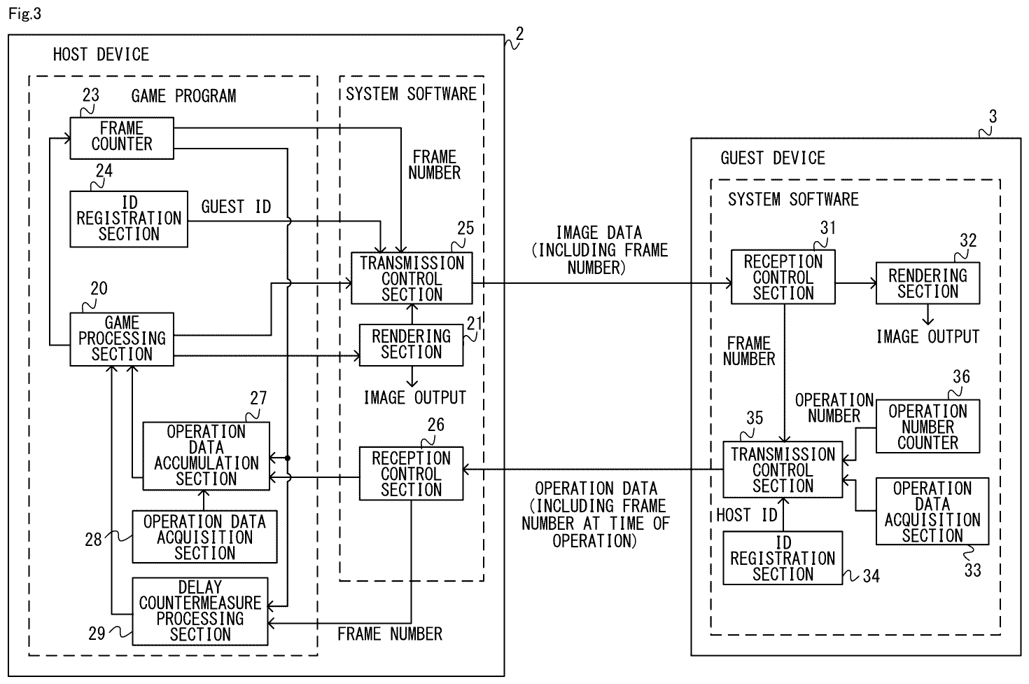

Referring to FIG. 3 to FIG. 7, examples of operations performed by the information processing devices when a game is executed in the information processing system will be described below. Each operation may be implemented by software or hardware, or by a combination of both. A case where the information processing device 2 operates as a host device and the information processing device 3 operates as a guest device will be described as an example. Note that in the following description, explanations of the function block sections (such as “game processing section 20” and “rendering section 21”) and terms (such as “frame number”) are intended to explain specific implementation examples and operations of the function blocks, etc., of the present embodiment, and the explanations may therefore become specific to the present embodiment for the sake of discussion in order to facilitate the understanding of the embodiment, but they are not intended to limit the scope of the functional blocks or the terms.

FIG. 3 is a functional block diagram showing an example of functions of the host device and the guest device. The host device 2 includes the elements 20 to 25 shown in FIG. 3 as functions for executing the game process based on a game program, displaying the generated game image on the host device 2, and transmitting the game image to the guest device 3.

A game processing section 20 executes the game process for advancing the game based on operation data of the host device and the guest device (e.g., the process of controlling objects in the game space, updating parameters indicating the game status, etc.). The game processing section 20 passes game parameters indicating the results of the game process (e.g., parameters indicating the game status, such as the positions and states of objects in the game space) to a rendering section 21.

The rendering section 21 renders a game image based on the game parameters received from the game processing section 20. That is, the rendering section 21 renders, to the frame buffer, a game image generated based on the game parameters. Thus, in the present embodiment, the game image is generated on the host device 2 side. Note that in the present embodiment, the game image is generated by rendering to a frame buffer, but the generation of the game image in the host device 2 is not limited thereto. For example, the game image may be generated in another memory without being rendered directly to the frame buffer to be thereafter transferred to the frame buffer. The rendering section 21 generates one or more game image to be displayed on the information processing devices (e.g., the host device 2 and the guest device 3). The game image for the host device and the game image for the guest device may be the same or different. For example, in the case of a fighting game, the same game image may be displayed on the information processing devices, and in the case of a racing game, different game images may be displayed on the information processing devices. When the game images are different from each other, the rendering section 21 generates a game image for the host device and another game image for the guest device. On the other hand, when the same game image is used, the rendering section 21 may generate only one game image. Where there are a plurality of guest devices, the game images may be the same for the guest devices or may be different for each guest device.

Of the generated game images, the game image for the host device is output to the display 13 of the host device 2. The rendering section 21 passes, of the generated game images, the game image for the guest device (which may be the same as the game image for the host device as described above) to a transmission control section 25.

The rendering section 21 repeatedly generates a game image in the first cycle. In the present embodiment, the period during which one game image for the host device is generated and displayed is defined as one frame. The length of the first cycle (e.g., one frame) is 1/60 [sec], for example. Note that in the present embodiment, the game image for the guest device may be generated in a second cycle (e.g., 1/30 [sec], etc.) that is longer than the first cycle. Specifically, the game image for the guest device is generated at a rate of once per two frames (i.e., at half the frequency of the game image for the host device).

The transmission control section 25 transmits the game image for the guest device to the guest device 3 using the communication module 14. In the present embodiment, transmission by the transmission control section 25 is performed in response to receiving an instruction from the game processing section 20. In the present embodiment, the transmission control section 25 generates image data for transmission by performing a predetermined process on the game image for the guest device passed from the rendering section 21. Specifically, the transmission control section 25 executes the process of reducing the resolution of the game image for the guest device passed from the rendering section 21, and then encodes the processed game image. Thus, it is possible to reduce the amount of image data to be transmitted to the guest device 3. Note that in other embodiments, the transmission control section 25 may not execute the process of reducing the resolution and the encoding process.

In the present embodiment, the transmission control section 25 transmits the game image to the guest device 3 with a frame number associated with the game image. Here, a frame counter 23 counts the number of frames each time a game image for the host device is generated and passes the frame number indicating the current frame number to the transmission control section 25. For example, the game processing section 20 notifies the frame counter 23 in response to the generation of the game image, and the frame counter 23 counts the number of frames in response to this notification. The transmission control section 25 includes the frame number information passed from the frame counter 23 in the game image data. Note that the frame number indicates the frame number when the game image for the host device corresponding to the game image for the guest device that is associated therewith is generated (or rendered). When the rendering and display of a single game image are performed within one frame period in the host device 2, the frame number may can also be said to indicate the frame number at which the game image for the host device corresponding to the game image for the guest device that is associated therewith is displayed.

In the present embodiment, the transmission control section 25 associates the frame number described above with the game image by embedding (or writing) the frame number information in the metadata area of the encoded game image data. This enables the efficient generation and transmission of the game image with the frame number. Note that in other embodiments, there is no limitation on the method of associating game images with frame numbers, and they may be transmitted as separate data while providing information that is related to the correspondence therebetween.

An ID registration section 24 stores the ID of the guest device 3 in the DRAM 15. For example, in response to the determination of the guest device to be the communication partner when the game starts, the ID registration section 24 stores the ID of the guest device in the DRAM 15. The transmission control section 25 acquires the ID of the guest device 3 from the ID registration section 24 and transmits the game image associated with the frame number to the information processing device indicated by the acquired ID. As described above, in the present embodiment, the game image for the guest device is generated once per two frames, and the transmission of the game image to the guest device 3 is also performed once per two frames. Note that it is also possible to generate game images for guest devices once per frame and transmit them per two frames (in this case, for example, some of the generated data may be not used or may be synthesized).

When the game image is transmitted from the host device 2 to the guest device 3 as described above, the game image is rendered (e.g., written to a frame buffer) and displayed on the guest device 3. The guest device 3 also transmits operation data indicating an operation thereon to the host device 2. In the present embodiment, the guest device 3 includes the elements 31 to 36 shown in FIG. 3 as functions for rendering the game image and transmitting the operation data to the host device 2.

The reception control section 31 receives image data transmitted from the host device 2 using the communication module of the guest device 3. The reception control section 31 decodes the image data and then passes the image data to the rendering section 32, and also passes the frame number information embedded in the image data to the transmission control section 35.

The rendering section 32 executes the rendering process related to the game image for the guest device passed from the reception control section 31. That is, the rendering section 32 writes the game image to the frame buffer. The game image written to the frame buffer is output to the display of the guest device 3 at a rate of once per frame. Note that in the present embodiment, as described above, the game image is transmitted to the guest device 3 at a rate of once per two frames as described above, but the rendering section 32 renders the game image at a rate of once per frame. That is, when no new game image is received, the rendering section 32 renders the same game image as the previous frame. Note that in other embodiments, the rendering section 32 may render the game image in response to newly receiving the game image, and not perform the rendering process (e.g., not update the frame buffer) in frames in which no game image is received.

The operation data acquisition section 33 acquires operation data output from the input section of the guest device 3 and passes it to the transmission control section 35. Note that in the present embodiment, the operation data is acquired in a predetermined cycle. There is no limitation on the length of the predetermined cycle, but in the present embodiment, it is performed in the first cycle (e.g., every frame). The transmission control section 35 transmits the operation data received from the operation data acquisition section 33 to the host device 2 using the communication module of the guest device 3.

In the present embodiment, the transmission control section 35 transmits the frame number embedded in the game image at the time of acquisition of operation data while associating the frame number with the operation data. Note that “game image at the time of acquisition of operation data” means a game image that is rendered (e.g., has been rendered) at the time of acquisition, a game image that is being rendered at that time (e.g., a game image that is being written to a frame buffer), a game image that has been received at that time, and a game image that is displayed at that time. In the present embodiment, the transmission control section 35 associates the frame number last received from the reception control section 31 with the operation data. Therefore, in the present embodiment, the operation data is associated with a frame number associated with the game image being rendered in the frame buffer when the operation data is acquired. Note that in the present embodiment, the transmission of operation data is performed in the predetermined cycle.

Note that, as will be described in detail later, the operation data of the host device 2 is associated with the frame number at the time of acquisition of the operation data (operation data of the host device 2) (in the present embodiment, the frame number corresponding to the game image being rendered or displayed on the host device 2). Therefore, because the frame number is associated with operation data on the side of the guest device 3 as described above, for the operation data of the host device 2 and the operation data of the guest device 3, operation data that are associated with the same frame number are those acquired for game images generated at the same timing.

In the present embodiment, the transmission control section 35 transmits operation data with the operation number in addition to the frame number associated with the operation data. Specifically, the operation number counter 36 counts the operation number and passes the current operation number to the transmission control section 35. The transmission control section 35 transmits the operation number passed from the operation number counter 36 while associating the operation number with the operation data. The operation number is counted incrementally when the frame number associated with the operation data to be transmitted in the current iteration is the same as the frame number associated with the operation data transmitted in the previous iteration (this occurs when operation data are acquired multiple times while the same game image is being rendered). The operation number is reset to 0 when the frame number associated with the operation data to be transmitted in this iteration is different from the frame number associated with the operation data transmitted in the previous iteration (i.e., when a game image different from the previous frame is rendered). Therefore, for a series of operation data transmitted every frame, operation data with the same frame number is associated with different operation numbers (specifically, operation numbers that are incremented by 1).

The ID registration section 34 stores the ID of the host device 2 in the DRAM. For example, the ID registration section 34 stores the ID of the host device in the DRAM in response to the determination of the host device to be the communication partner when the game starts. The transmission control section 35 acquires the ID of the guest device 3 from the ID registration section 34 and transmits the operation data to the information processing device indicated by the acquired ID.

When operation data is transmitted from the guest device 3 to the host device 2 as described above, the host device 2 executes the game process based on the operation data. In the present embodiment, the host device 2 includes the elements 20, 26 to 29 shown in FIG. 3 as functions for executing the game process based on the operation data.

The reception control section 26 receives operation data transmitted from the guest device 3 using the communication module 14. The reception control section 26 passes the operation data and the frame number and operation number associated therewith to the operation data accumulation section 27, and extracts the frame number and operation number from the received data and passes them to the delay countermeasure process section 29.

The operation data accumulation section 27 stores, in the DRAM 15, the operation data from the guest device 3 and the frame number and operation number associated therewith. Since operation data from the guest device 3 is additionally stored in the DRAM 15 every time operation data is received, the operation data are accumulated in the DRAM 15.

The operation data acquisition section 28 acquires operation data output from the input section 12 of the host device 2 and passes it to the operation data accumulation section 27. Then, an operation data accumulation section 27 acquires the frame number at the time of acquisition of the operation data of the host device 2 from the frame counter 23, and additionally stores the frame number and the operation data in DRAM 15 so that they are associated with each other. Thus, the operation data of the host device 2 is also stored in the DRAM 15 in the same manner as the operation data of the guest device 3. Note that the acquisition of the operation data of the host device 2 is performed in the predetermined cycle (e.g., at the same frequency as the acquisition of the operation data of the guest device 3).

As described above, in the present embodiment, the operation data of the host device 2 and the guest device 3 are acquired and accumulated for every frame. Note however that in other embodiments, the operation data of the host device 2 and the guest device 3 may be acquired and accumulated at an interval shorter than one frame (e.g., at a rate of multiple times per frame period).

The delay countermeasure process section 29 executes a countermeasure process against communication delays occurring between the host device 2 and the guest device 3. In the present embodiment, the delay countermeasure process section 29 calculates the delay amount in communication between the host device 2 and the guest device 3 based on the frame number and operation number (i.e., the frame number and operation number associated with the operation data from the guest device 3) received from the reception control section 26, and the frame number indicating the current frame output from the frame counter 23. Note that the specific method for calculating the delay amount will be described later. For example, the delay countermeasure process section 29 calculates the delay amount each time operation data is received from the guest device 3. Note that the timing for calculating the delay amount is not limited to this, and in other embodiments, the delay amount may be calculated at a rate of once per a predetermined number of frames, or the delay amount may be calculated at a rate of once per a predetermined number of operation data received from the guest device 3.

In the present embodiment, the delay countermeasure process section 29 selects, based on the delay amount, operation data to be used for the game process from among the accumulated operation data (e.g., the operation data of the host device 2 and the operation data of the guest device 3). Note that the method for selecting operation data based on the delay amount will be described later. Information indicating the selected operation data is passed from the delay countermeasure process section 29 to the game processing section 20. The game processing section 20 acquires the selected operation data from the accumulated operation data based on the information received from the delay countermeasure process section 29, and executes the game process based on the acquired operation data.

As shown in FIG. 3, in the present embodiment, the functions of the elements 20 to 29 of the host device 2 are executed collaboratively by the game program and the system software. For example, when the system software executed by the computer (e.g., the processor provided in the SoC 11) receives a game image for the guest device from the game program, the transmission control section 25 acquires the frame number from the frame counter 23, performs the embedding process described above, and transmits the game image to the recipient set in accordance with an instruction of the game program at the start of the game. The reception control section 26 performs the process in which the system software receives the operation data and the frame number from the guest device 3, and the data are passed to the game program. According to the above, the information processing device can have the function of transmitting the game image with the frame number associated therewith, and the function of extracting the frame number (and the operation number) from the operation data received from the guest device 3, without installing a specific game program. This eliminates the need to create these functions for each game program, thereby improving the efficiency in game program development.

As shown in FIG. 3, in the present embodiment, the elements 31 to 35 of the guest device 3 are realized by a computer (in other words, the processor) executing the system software. According to the above, the information processing device can operate as a guest device without installing a specific game program. According to this, in order to play a game using a host device and a guest device, it is only required to install the game program on the host device, and there is no need to install the game program on the guest device, thereby improving user convenience.

In the present embodiment, by means of the system software, a single information processing device has both the function of the transmission control section 25 and the reception control section 26 on the host device side and the function of the elements 31 to 35 on the guest device side (see FIG. 2 and FIG. 3). According to this, the information processing device can operate as either a host device or a guest device. Therefore, when a user plays a game of a game program stored in an information processing device of the user, the user can play a multi-player game while using the user's information processing device as a host device and using other users' information processing devices as guest devices. When a user plays a game of a game program stored in an information processing device of another user, the user can play a multi-player game while using the user's information processing device as a guest device and using the information processing device of the other user as a host device. This further improves user convenience.

Note that there is no limitation on what functions of the information processing device are realized by the game program and what functions of the information processing device are realized by the system software. For example, in other embodiments, the function of receiving operation data in the host device 2 may be realized by the game program, or all of the functions shown in FIG. 3 may be realized by the game program.

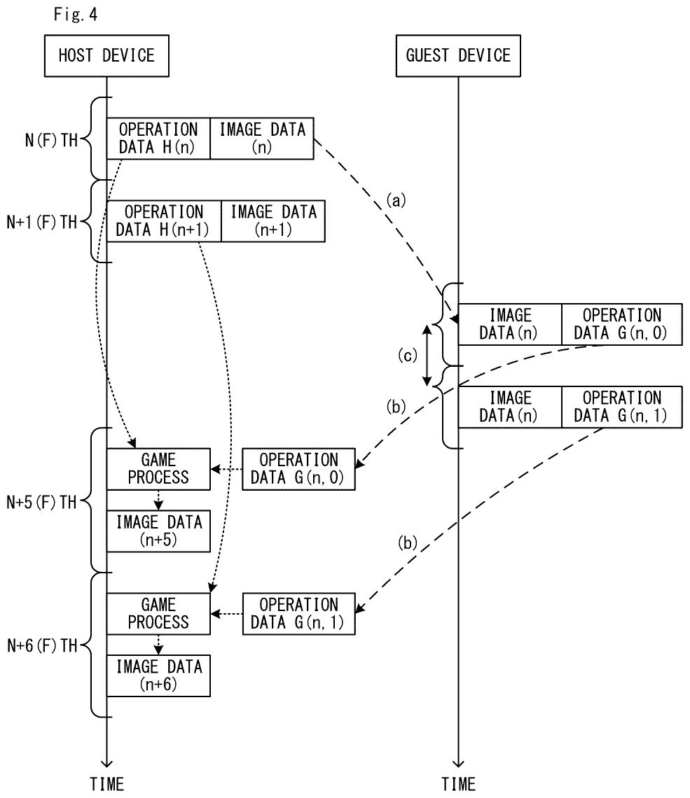

Next, referring to FIG. 4, an example of a method for calculating the delay amount will be described. FIG. 4 is a diagram showing an example of a flow until the game process using operation data acquired in the n^{th} frame and in the n+1^{th} frame is executed, where the n^{th} frame is defined as a certain frame in the host device 2.

Note that in FIG. 4, image data of a game image rendered on the host device 2 or transmitted to the guest device 3 in the n^{th} frame (n is a natural number) on the host device 2 is denoted as “image data (n)”. Moreover, operation data of the host device acquired when the game image of the n^{th} frame is rendered is denoted as “operation data H(n)”. Operation data of the guest device associated with the n^{th} frame (n is a natural number) and associated with an operation number of m (m is a natural number) is denoted as “operation data G(n, m).”.

In the example shown in FIG. 4, in the n^{th} frame at the host device 2, the operation data H(n) of the host device 2 is acquired, and a game image based on the game process is generated. As described above, the acquired operation data H(n) is accumulated in the host device 2, and the image data (n) generated for the guest device is transmitted to the guest device 3.

In the n+1^{th} frame at the host device 2, as in the n^{th} frame, operation data of the host device 2 is acquired, and a game image based on the game process is generated. The operation data H(n+1) acquired in the second frame is accumulated in the host device 2. Here, in the present embodiment, since the game image for the guest device is generated at a rate of once per two frames, in the example shown in FIG. 4, no game image for the guest device is generated or transmitted in the n+1^{th} frame.

At the guest device 3, due to a communication delay, the image data (n) transmitted from the host device 2 is received at a timing different from the timing at which the image data (n) is rendered on the host device 2, and the image data (n) is rendered on the guest device 3. Then, the operation data acquired in the frame in which the image data (n) is rendered for the first time is “operation data G(n, 0)” where the associated frame number is “n” and the associated operation number is “0” (see FIG. 4). In this frame, the guest device 3 transmits the operation data G(n, 0) to the host device 2.

In the next frame after the image data (n) is rendered on the guest device 3, no image data from the host device 2 is received, and the image data (n) is rendered again. Then, the operation data acquired in this frame is “operation data G(n, 1)” where the associated frame number is “n” and the associated operation number is “1” (see FIG. 4). In this frame, the guest device 3 transmits the operation data G(n, 1) to the host device 2.

Note that in the present embodiment, since image data is transmitted from the host device 2 to the guest device 3 at a rate of once per two frames, rendering of a new game image is performed basically at a rate of once per two frames in the guest device 3. However, in practice, due to the influence of communication status, etc., it is not necessarily the case that one image data is received by the guest device 3 every two frames. Therefore, for example, the same game image may be rendered consecutively for three or more frames. In this case, the operation number associated with the operation data will be a value of 2 or more. Depending on the communication status, there may be only one operation data for a given game image, in which case there will be no operation data with an operation number of “1”.

When the host device 2 receives operation data transmitted from the guest device 3, the host device 2 calculates the delay amount based on the frame number and operation number associated with the operation data and the timing of receiving the operation data. Here, the delay amount can be calculated, for example, as the length of time from when image data is transmitted from the host device 2 to the guest device 3 to when the operation data corresponding to the image data (e.g., the operation data acquired in the frame in which the image data is rendered) is transmitted from the guest device 3 and received by the host device 2. That is, the delay amount can be regarded as the sum of the amount of time required for image data to be transmitted from the host device 2 to the guest device 3 ((a) shown in FIG. 4) and the amount of time required for operation data to be transmitted from the guest device 3 to the host device 2 ((b) shown in FIG. 4).

Here, when the operation data acquired in the frame in which the image data is rendered for the first time after being received at the guest device 3 (e.g., operation data whose operation number is 0) is received at the host device 2, the length of the period corresponding to the delay amount is the difference between the current frame number (e.g., the value of the frame counter at the time when the operation data was received) and the value of the frame number associated with the operation data. Therefore, the delay amount can be calculated by the difference. In the example shown in FIG. 4, since operation data G(n, 0) whose frame number is n is received in the n+5^{th} frame at the host device 2, the delay amount at this time can be calculated as 5 (frames).

On the other hand, when operation data acquired in the frame in which image data is rendered at the guest device 3 for the second time or later after the image data is received (e.g., operation data whose operation number is 1 or more) is received at the host device 2, the difference described above is the sum of the time (a) above, the time (b) above, and the amount of time from when the image data is rendered for the first time to when the operation data is acquired ((c) shown in FIG. 3, e.g., one frame). Therefore, the difference described above does not accurately indicate the delay amount. Here, since the operation number associated with the operation data indicates the time (c), in the case described above, it is possible to calculate the delay amount based on the frame number and the operation number. Specifically, in the case described above, the delay amount can be calculated as the difference obtained by subtracting the sum of the frame number and the operation number associated with the operation data from the current number of frames. In the example shown in FIG. 4, since operation data G(n, 1) whose frame number is n and operation number 1 is received in the n+6^{th} frame at the host device 2, the delay amount can be calculated as 5 (frames).

From the above, in the present embodiment, the delay amount is calculated according to Equation (1) below.

(Delay amount)=(Current frame number)−{(Frame number associated with operation data of guest device 3)+(Operation number associated with operation data of guest device 3)} (1)

In the present embodiment, since the operation number associated with the operation data acquired in the frame in which image data is rendered for the first time after being received at the guest device 3 is set to 0, the delay amount can be calculated by Equation (1) above when operation data whose operation number is 0 is received and also when operation data whose operation number is 1 or more is received.

Note that in the present embodiment, since image data is transmitted from the host device 2 to the guest device 3 every two frames, and since the same game image is rendered over multiple frames in the guest device 3, each operation data is assigned an operation number in order to distinguish between operation data acquired over the multiple frames. Then, it is possible to calculate the delay amount based on the frame number and the operation number in the host device 2 as described above.

Note that in other embodiments, the information processing system 1 may associate operation data only with the frame number without the operation number. Then, the host device 2 may calculate the delay amount based on the frame number in the frame in which the operation data associated with a new frame number is received, and may execute the game process based on the last calculated delay amount without calculating a new delay amount in the frame in which the operation data associated with the same frame number as the previous iteration is received. Even without assigning operation numbers, the timing at which operations are performed on the guest device may be managed based on the order in which operation data are received.

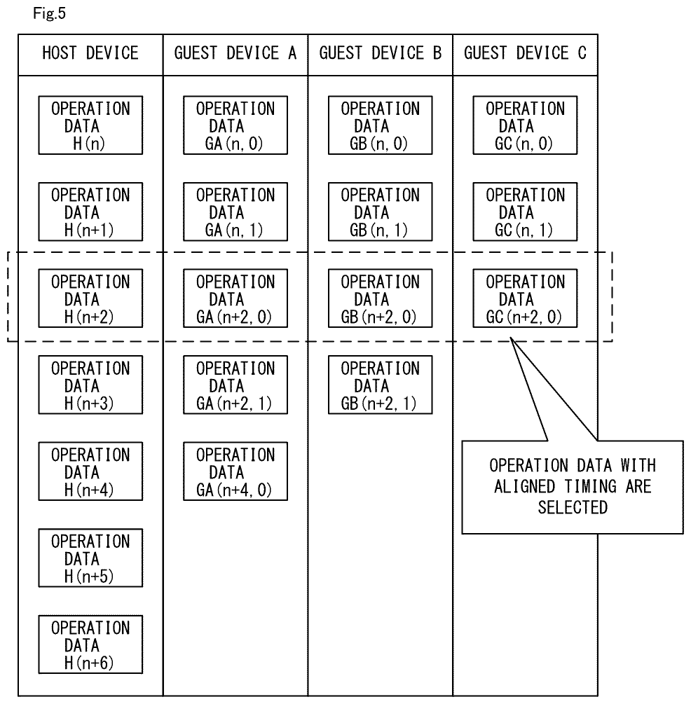

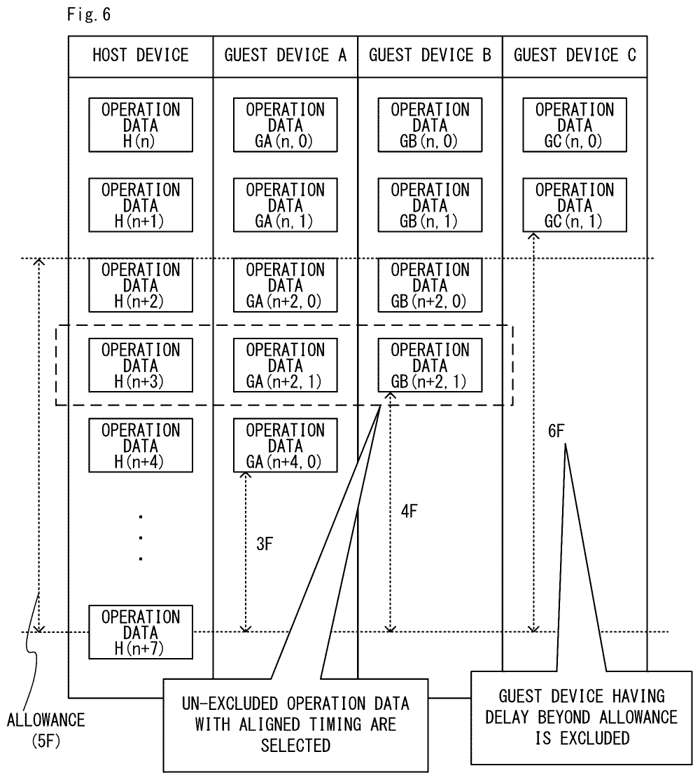

Note that the method of calculating the delay amount using the frame number is not limited to the above and may be performed by other methods. For example, in other embodiments, the host device 2 may not calculate the delay amount each time the host device 2 receives operation data from the guest device, but may calculate the delay amount at a regular interval that is longer than one frame. For example, the host device 2 may calculate the delay amount at the current point in time based on delay amounts that have been calculated over multiple iterations up to the current point in time (e.g., by calculating the average value of the delay amounts calculated over multiple iterations). For example, the host device 2 does not need to repeatedly calculate the delay amount, and may calculate the delay amount at a predetermined timing in the game (e.g., at the timing when the start of the game). The host device 2 may calculate the delay amount without using the frame number (e.g., by a conventional method), and may select operation data by the method to be described below (see FIG. 5 and FIG. 6) using the delay amount not based on the frame number.

In the game process in the host device 2, the operation data used for the game process is selected for each of the operation data of the host device 2 and the guest device 3 based on the delay amount calculated as described above. As will be described in detail later, in the present embodiment, the host device 2 selects operation data that has been acquired in a frame preceding the current frame by the delay amount or more such that the operation data of the host device 2 and the operation data of the guest device 3 have the same frame number. For example, in the example shown in FIG. 4, since the delay amount is calculated to be 5 frames in the n+5^{th} frame, the game process is executed using operation data H(n) whose frame number is n and operation data G(n, 0). In the n+6^{th} frame, since the delay amount is calculated to be 5 frames, the game process is executed using operation data H(n+1) whose frame number is n+1 and operation data G(n, 1). According to this, since the operation data of the host device 2 and the operation data of the guest device 3 used for the game process are those acquired for the game image generated at the same timing, it is possible to reduce the possibility of creating advantages/disadvantages in the game between the host device 2 and the guest devices 3.

Next, referring to FIG. 5 and FIG. 6, an example of an operation data selection method will be described. In FIG. 5 and FIG. 6, a case where the information processing system 1 includes three guest devices A to C will be described as an example. In this case, image data and operation data are transmitted and received between the host device 2 and the guest devices by the method described above. In FIG. 5 and FIG. 6, operation data are denoted with signs (e.g., H(n), etc.) in the same manner as the method shown in FIG. 4. Note however that operation data of the guest devices A to C are denoted as “operation data GA(n, m)”, “operation data GB(n, m)”, and “operation data GC(n, m)”.

FIG. 5 is an example of operation data accumulated in the host device 2 in a frame. FIG. 5 shows a point in time where the host device 2 is at the n+6^{th} frame, and operation data H(n) to H(n+6) have been accumulated as the operation data of the host device 2. At this point in time, operation data GA(n, 0) to GA(n+4, 0) have been acquired as the operation data of the guest device A, operation data GB(n, 0) to GB(n+2, 1) have been acquired as the operation data of the guest device B, and operation data GC(n, 0) to GC(n+2, 0) have been acquired as the operation data of the guest device C.

When there are multiple guest devices, the host device 2 calculates the delay amount between the host device 2 and each of the guest devices A to C. In the example shown in FIG. 5, the delay amounts between the host device and the guest devices A to C are calculated as 2 (frames), 3 (frames), and 4 (frames), respectively, according to Equation (1) above.

In the present embodiment, the host device 2 sets, as the reference delay amount, the largest one of the delay amounts between the host device 2 and the guest devices A to C. Then, for the operation data of the information processing devices (e.g., the host device and the guest devices), operation data is selected that is associated with a frame number indicating a frame preceding the current frame by the reference delay amount (hereinafter referred to as the “reference frame”). In the example shown in FIG. 5, the reference delay amount is calculated as 4 (frames), and as a result, operation data whose frame number is n+2 is selected for the information processing devices (see FIG. 5).

Note that in the present embodiment, image data is transmitted from the host device 2 to the guest device 3 once per two frames, and therefore, for the operation data of the guest device, there is no operation data associated with a frame number of a frame in which no image data is transmitted. For example, in the present embodiment, image data is not transmitted either in even-numbered frames or in odd-numbered frames (the n+1^{th} frame in the example shown in FIG. 4). For example, if image data is not transmitted in even-numbered frames, there is no operation data where the frame number is an even number for the operation data of the guest device, and instead, multiple operation data whose frame numbers are odd numbers are accumulated. In the example shown in FIG. 5, there is no operation data whose frame number is n+1 or n+3 for the operation data of the guest device, and multiple operation data whose frame numbers are n or n+2 are accumulated. In view of the above, in the present embodiment, for the operation data of the guest device, when no operation data associated with a frame number indicating the reference frame is accumulated, the host device 2 selects the oldest operation data (e.g., with the smallest operation number) that has not yet been selected from among the operation data associated with a frame number obtained by subtracting 1 from the frame number of the reference frame. For example, when the reference frame is determined to be the n+3^{th} frame based on the reference delay amount, for the operation data of the guest device, the oldest operation data that has not yet been selected from among the operation data whose frame number is n+2 is selected.

Note that, although different from FIG. 5 and FIG. 6, the host device 2 may be configured so that only operation data that have not yet been selected (e.g., operation data that have not been used for the game process) are stored in the DRAM 15 by deleting operation data that has been selected for the game process in a certain frame from the DRAM 15. At this time, the host device 2 can select the oldest operation data that has not yet been selected by selecting the operation data with the smallest operation number from among the operation data stored in DRAM 15 that are associated with the frame number of the reference frame (or the frame number obtained by subtracting 1 from the reference frame).

As described above, in the present embodiment, the host device 2 selects a set of operation data associated with frame numbers of equivalent timing from among the operation data of the host device 2 and the operation data of the guest device, and executes the game process based on the selected operation data. According to this, since the game process is executed using the operation data that have been acquired at the same (or almost the same) time in the game, it is possible to reduce the possibility of creating advantages/disadvantages in the game between the host device and the guest devices.

Note that the “set of operation data associated with frame numbers of equivalent timing” above means that the frame numbers do not need to be exactly the same in the strict sense, but rather means to include a set of operation data selected so that the frame numbers of the operation data fall within a certain range. For example, the host device 2 may select the oldest operation data that has not yet been selected within a range of frame numbers indicating a predetermined number of frames before and after the reference frame.

In the present embodiment, as described above, operation data is selected based on the largest one of the delay amounts between the host device and the guest devices (i.e., the reference delay amount). According to this, a situation in which operation data associated with the frame number of the reference frame has not yet been received by the host device 2 is less likely to occur, and it is more likely to select a plurality of operation data associated with frame numbers of equivalent timing. This reduces the possibility of creating advantages/disadvantages in the game between a plurality of guest devices.

It should be noted that it is not necessary to calculate and use the delay amount when using a set of operation data associated with frame numbers of equivalent timing. However, if, for example, the delay amount for a certain guest device becomes very large, operation data from a point in time much earlier than the current point in time will be used for the game process, and the operation response for all players will deteriorate significantly due to the large delay amount for the certain guest device. Therefore, in the present embodiment, a tolerance value (which can be called an upper limit value) is set for the reference delay amount.

FIG. 6 is a diagram showing an example of operation data stored in the host device 2 in a certain frame. In FIG. 6, the host device 2 is at the n+7^{th} frame, for example, and operation data from operation data H(n) to operation data H(n+7) are accumulated as operation data of the host device 2. Also, at this point in time, operation data from operation data GA(n, 0) to operation data GA(n+4, 0) have been acquired as operation data of the guest device A, operation data GB(n, 0) to operation data GB(n+2, 1) have been acquired as operation data of the guest device B, and operation data GC(n, 0) to GC(n, 1) have been acquired as operation data of the guest device C.

In the example shown in FIG. 6, the delay amounts between the host device and the guest devices A to C are calculated as 3 (frames), 4 (frames), and 6 (frames), respectively.

Here, in the example shown in FIG. 6, it is assumed that 5 (frames) is set as the tolerance value. The host device 2 determines the reference delay amount while using the tolerance value as the upper limit. Specifically, the reference delay amount is determined to be the largest of the delay amounts between the host device 2 and the guest devices within a range that does not exceed the tolerance value. In the example shown in FIG. 6, the delay amount between the host device 2 and the guest device C is 6 (frames), which exceeds the tolerance value, so the reference delay amount is determined to be 4 (frames) based on the delay amount between the host device 2 and the guest device B. Note that there is no limitation on the tolerance value, and the tolerance value may be set to an arbitrary value in consideration of the content of the game, etc.

In the present embodiment, the host device 2 excludes a guest device whose delay amount is greater than the reference delay amount, and selects operation data based on the reference delay amount from among the operation data of other guest devices other than the guest device that has been excluded (hereinafter referred to as “excluded guest device”) and the operation data of the host device. In the example shown in FIG. 6, the guest device C whose communication delay is 6 (frames) is excluded, and operation data is selected based on the reference delay amount for the host device 2 and the guest devices A and B. As a result, the reference frame is determined to be the n+3^{th} frame, and operation data H(n+3), operation data GA(n+3, 1), and operation data GB(n+2, 1) are selected and used for the game process. Then, a set of operation data associated with frame numbers of equivalent timing are selected while keeping the difference between the current frame and the frame of the operation data used for the game process down to 4 (frames), though the delay amount between the host device 2 and the guest device C is 6 (frames).

As described above, in the present embodiment, among the delay amounts between the host device and the guest devices, the largest delay amount excluding those exceeding the tolerance value is set as the reference delay amount, and operation data are selected based on the reference delay amount. Thus, it is possible to reduce the possibility that the amount of time required for changes to occur in the game image in response to an operation performed by the user becomes too long.

Note that for the operation data for the excluded guest device, operation data may be selected based on a predetermined rule, and the selected operation data may be used for the game process. For example, the last acquired operation data among the accumulated operation data may be used for the game process. For example, operation data of the excluded guest device may not be used for the game process.

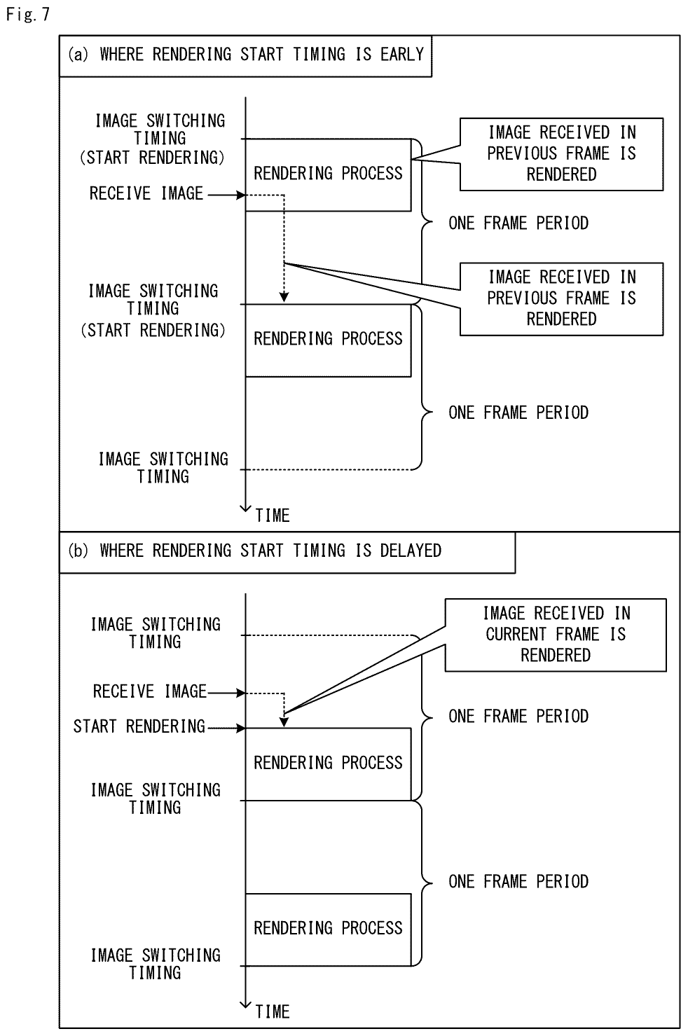

Next, referring to FIG. 7, the timing to start rendering the game image on the guest device will be described. Typically, the game image rendering process (e.g., writing to the frame buffer) is executed immediately after the image switching timing (sometimes called V-sync timing), which is the timing at which the image written in the frame buffer is displayed on the display device. The image switching timing is set at the beginning of each frame.

(a) in FIG. 7 shows a case where the rendering process starts at the same time as the image switching timing. (b) in FIG. 7 shows a case where the rendering process starts at a timing delayed from the image switching timing.

Here, in the case of (a) shown in FIG. 7, since the rendering process is started at the same time as the image switching timing, even if the game image is received before the next image switching timing, the rendering process has already started, so the received game image cannot be rendered, and the game image cannot be displayed at the next image switching timing. That is, in the case of (a) shown in FIG. 7, the game image rendered in the rendering process in a certain frame is the game image received in the previous frame. In other words, the received game image is rendered in the rendering process in the next frame period. Thus, with an ordinary method, the timing of displaying the received game image on the guest device 3 is delayed.

On the other hand, in the case of (b) shown in FIG. 7, since the rendering process starts later than the image switching timing, even after the image switching timing, the received game image can be rendered in the frame if the game image is received by the guest device 3 before the rendering process start timing. Therefore, in the case of (b) shown in FIG. 7, the timing of displaying the received game image on the guest device 3 can be earlier than in the case of (a) shown in FIG. 7. Note that by setting the rendering process start timing to be as late as possible within one frame period, it is possible to increase the probability that the game image received in the frame is rendered in the frame. According to this, the timing at which the game image is displayed on the guest device 3 can be made earlier, so that the delay countermeasure can also be implemented also as described above in the present embodiment.

From the above, in the present embodiment, the rendering section 32 of the guest device 3 starts the rendering process at a timing later than the start of a frame period, as in (b) shown in FIG. 7. Specifically, the rendering section 32 starts the rendering process at a timing that is a predetermined amount of time before the end timing of one frame period (which can also be said to be a timing that is a predetermined amount of time before or after the image switching timing). The rendering process start timing may be any timing between the image switching timing and the next image switching timing. That is, the predetermined amount of time may be any length greater than 0 and shorter than the length of one frame. In the present embodiment, the predetermined amount of time is set to the amount of time required for rendering the game image (i.e., the amount of time required for rendering the image data to the frame buffer). That is, a timing that is the predetermined amount of time before the image switching timing is set as the rendering process start timing. According to this, it is possible to end the rendering process before the end timing of one frame period, thereby increasing the possibility of rendering the game image received in the frame within that frame and displaying the game image at the next image switching timing. Note that the amount of time set as the “amount of time required for rendering the game image” is determined based on the hardware performance of the guest device 3, etc. In other embodiments, the amount of time may be set to be variable. In other embodiments, the predetermined amount of time may be set to an amount of time obtained by adding a margin time to the amount of time required for rendering the game image. Therefore, it is possible to provide a margin to the amount of time from the end timing of the rendering process to the end timing of one frame period.

Although not shown in the figures, on the host device 2 side, the rendering of the game image starts at the start timing of one frame period. That is, the rendering section 21 of the host device 2 starts rendering the game image at the image switching timing. This is because the host device 2 does not render a game image received from another device, and the amount of time required for rendering the game image is relatively long and varies depending on the game status, so there is little advantage in delaying the rendering process in one frame period. By starting rendering at the start timing of one frame period, the rendering process can be completed more reliably within that frame.

In the present embodiment, the image switching timing at the host device 2 and the image switching timing at the guest device 3 are not synchronized, and they are set independently. According to this, the host device 2 and the guest device 3 can render and display the game image without being subject to restrictions that would arise when the image switching timing is synchronized therebetween. For example, it is possible to reduce the possibility of delay in rendering and displaying the game image due to such restrictions. Note that in other embodiments, the image switching timing may be synchronized between the host device 2 and the guest device 3.

### [3. Specific Examples of Processes in Information Processing System]

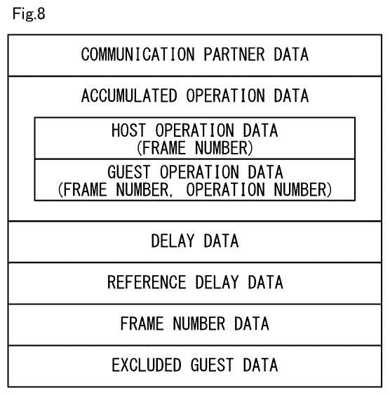

Next, referring to FIG. 8 to FIG. 14, specific examples of information processes executed in the information processing system 1 will be described.

FIG. 8 is a diagram showing an example of various data used for information processes in the host device 2. As shown in FIG. 8, the host device 2 stores communication partner data, accumulated operation data, delay amount data, reference delay amount data, frame number data, and excluded guest data. Each data shown in FIG. 8 is stored in a storage medium (e.g., the DRAM 15) accessible by the host device 2.

The communication partner data indicates the ID of the guest device to be the communication partner.

The accumulated operation data is operation data of the host device 2 or the guest device 3 accumulated in the host device 2. The host operation data accumulated as operation data of the host device includes data of a frame number associated with the operation data. The guest operation data accumulated as operation data of the guest device includes data of a frame number and an operation number associated with the operation data.

The delay amount data indicates the delay amount between the host device 2 and the guest device 3. Note that when there are a plurality of guest devices, the delay amount data is stored for each guest device. The reference delay amount data indicates the reference delay amount described above.

The frame number data indicates the current frame number counted by the frame counter 23.

The excluded guest data indicates guest devices set as excluded guest devices described above.

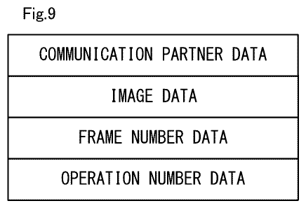

FIG. 9 is a diagram showing an example of various data used for information processes in the guest device 3. As shown in FIG. 9, the guest device 3 stores communication partner data, image data, frame number data, and operation number data. Each data shown in FIG. 9 is stored in a storage medium (e.g., the DRAM 15) accessible by the host device 2.

The communication partner data indicates the ID of the host device to be the communication partner.

The image data is image data that is transmitted from the host device 2 and received by the guest device 3.

The frame number data indicates the frame number associated with the image data received by the guest device 3.

The operation number data indicates an operation number associated with operation data transmitted from the guest device 3 to the host device 2.

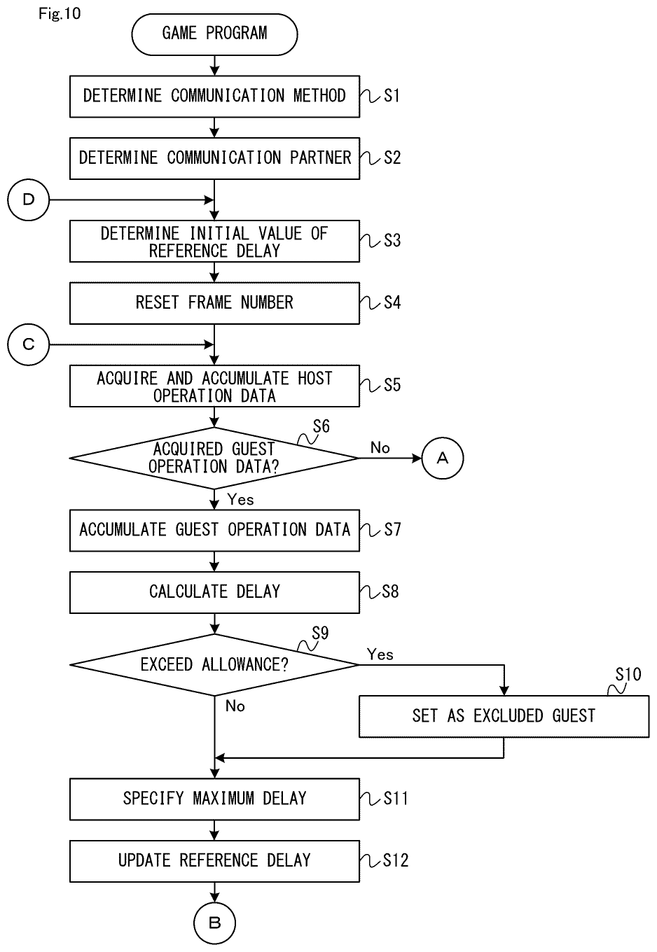

Hereinafter, referring to FIG. 10 to FIG. 14, examples of information processes executed in the host device 2 and the guest device 3 will be described. Note that in the present embodiment, the processor of the information processing device (e.g., the host device 2 or the guest device 3) executes the processes of the steps shown in FIG. 10 to FIG. 14 by executing a program (e.g., a game program, a host program, or a guest program) stored in the information processing device. Note that the processor may be the CPU or GPU described above, or may be a dedicated circuit. If the information processing device is capable of communicating with other information processing devices (e.g., a server), some of the processes of the steps shown in FIG. 10 to FIG. 14 may be executed by the other information processing devices. The processes of the steps shown in FIG. 10 to FIG. 14 are merely illustrative, and the order of steps to be performed may be switched around or other processes may be executed in addition to (or instead of) the processes of the steps, as long as similar results are obtained.

The processor executes the processes of the steps shown in FIG. 10 to FIG. 14 using memory (e.g., the DRAM 15 or the memory provided in the SoC). That is, the processor 81 stores the information (in other words, data) obtained by the processing steps in the memory, and when the information is used in subsequent processing steps, the information is read from the memory and used.

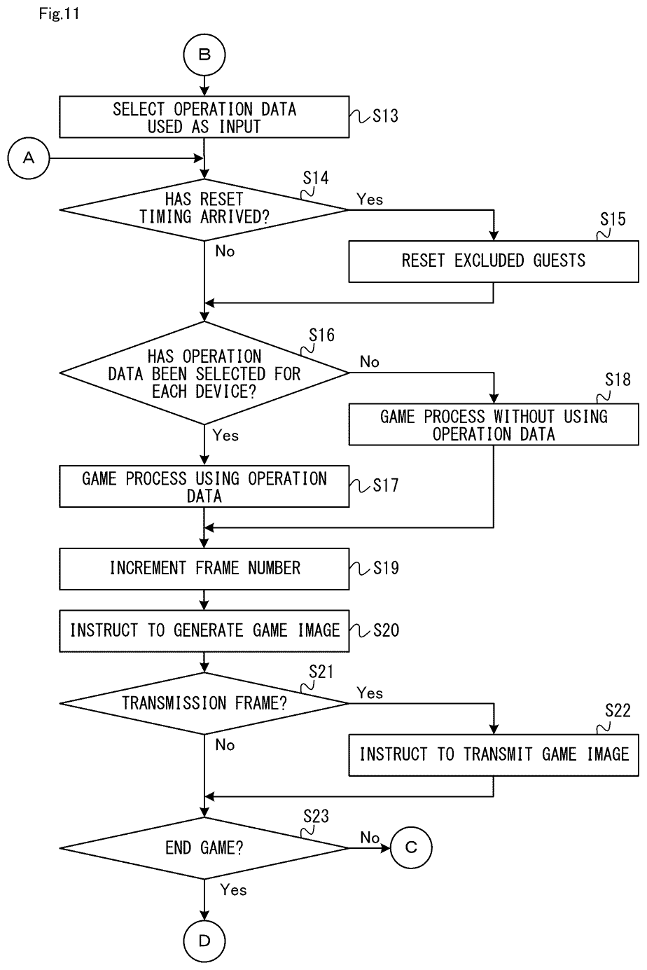

FIG. 10 and FIG. 11 are flow charts showing an example of the flow of information processes executed by the game program on the CPU of the host device 2. The process shown in FIG. 10 is started, for example, in response to an instruction by the player to start a game using multiple devices during the execution of the game program.

In step S1 shown in FIG. 10, the CPU determines the communication method with the guest devices. For example, the CPU determines whether to communicate in the first communication mode (e.g., Internet communication) described above or in the second communication mode (e.g., local communication) in response to a user instruction. The process of step S2 is executed, following step S1.

In step S2, the CPU determines the guest device to be the communication partner. There is no limitation on the method for determining the guest device. For example, when the host device 2 communicates via Internet communication, the guest device to be the communication partner may be determined by being specified by the server, or may be determined in response to an instruction from the user of the host device 2 from among candidates presented by the server. For example, the user of the host device 2 may be able to directly specify the communication partner. Specifically, the user of the host device 2 may specify the account of another user, thereby transmitting the information of the account to the server, so that the server identifies the information processing device corresponding to the user of the account, thereby determining the identified information processing device as the communication partner. Alternatively, the guest device may be determined by the user of the host device 2 specifying the ID of another information processing device, and the server that receives the ID may connect the communication between the other information processing device and the host device 2. For example, when the host device 2 communicates via local communication, the guest device to be the communication partner may be determined in response to a user instruction from among information processing devices that are capable of communicating with the host device 2. When the communication partner is determined, the CPU stores data indicating the ID of the guest device that is the communication partner in the memory as communication partner data. When the communication partner is determined by step S2, the game starts and a series of processes starting from step S3 are executed. Note that in the example shown in FIG. 10 and FIG. 11, the process loop including the series of processes of steps S3 to S23 is executed every 1/60 [sec].

In step S3, the CPU determines an initial value of the reference delay amount. Specifically, the CPU stores data indicating a predetermined initial value (e.g., the same value as the tolerance value) in the memory as reference delay amount data. The process of step S4 is executed, following step S3.

In step S4, the CPU resets the frame number to be counted. Specifically, the CPU stores data indicating 0 in the memory as frame number data. The process of step S5 is executed, following step S4.

In step S5, the CPU acquires the operation data of the host device from the input section 12 and stores the acquired operation data while associating the operation data with the frame number. Specifically, the CPU stores, in the memory, data including the acquired operation data and the frame number data stored in the memory as host operation data. The process of step S6 is executed, following step S5.

In step S6, the CPU determines whether or not operation data has been acquired from the guest device. Specifically, the CPU determines whether or not the operation data received from the guest device has been passed from the host program to the game program. If the determination result from step S6 is affirmative, the process of step S7 is executed. On the other hand, if the determination result from step S6 is negative, the process of step S14 (see FIG. 11) to be described below is executed.

In step S7, the CPU accumulates the operation data acquired in step S6. Specifically, since the acquired operation data is associated with a frame number and an operation number, the CPU stores, in the memory, the operation data including data indicating the frame number and the operation number as guest operation data. The process of step S8 is executed, following step S7.

In step S8, the CPU calculates the delay amount between the host device and the guest device based on the operation data acquired in step S6. That is, the CPU calculates the delay amount between the guest device that has transmitted the operation data and the host device according to the method described in FIG. 4. Data indicating the calculated delay amount is stored in the memory as delay amount data. Note that if delay amount data for the same guest device is already stored in the memory, the stored delay amount data is overwritten by the newly calculated delay amount data. The process of step S9 is executed, following step S8.

In step S9, the CPU determines whether the delay amount calculated in step S8 exceeds the tolerance value. If the determination result from step S9 is affirmative, the process of step S10 is executed. On the other hand, if the determination result from step S9 is negative, the process of step S11 is executed.

In step S10, the CPU sets the guest device that has been determined to have a delay amount exceeding the tolerance value as an excluded guest device. That is, the CPU stores, in the memory, data indicating the excluded guest device as excluded guest data. The process of step S11 is executed, following step S10.

Note that in a configuration with multiple guest devices, operation data may be acquired from multiple guest devices during the determination process in step S6 above. In this case, the processes in steps S7 to S10 are executed for each of the acquired operation data.

In step S11, the CPU identifies currently the largest delay amount among the delay amounts of the guest devices. That is, the CPU identifies the largest delay amount among the delay amounts indicated by the delay amount data stored in the memory. The process of step S12 is executed, following step S11.

In step S12, the CPU updates the reference delay amount. Specifically, the CPU sets, as the reference delay amount, the smaller of the tolerance value described above and the maximum delay amount identified in step S11. The reference delay amount data stored in the memory is updated to indicate the newly set reference delay amount. The process of step S13 is executed, following step S12.

In step S13 shown in FIG. 11, the CPU selects operation data to be used for the game process based on the reference delay amount updated in step S12. Specifically, the CPU selects operation data associated with frame numbers of equivalent timing from among the operation data included in the accumulated operation data stored in the memory by the method described above with reference to FIG. 5 and FIG. 6. Note that the operation data of any excluded guest device indicated by the excluded guest data stored in the memory is not selected in step S13. Even if the operation data is of a guest device that is not an excluded guest device, the operation data may not be selected for such a reason that the operation data corresponding to the reference frame based on the reference delay amount is not accumulated, for example. In the present embodiment, the CPU deletes the selected operation data from the accumulated operation data stored in the memory. The process of step S14 is executed, following step S13.

In step S14, the CPU determines whether or not the timing for resetting the guest device excluded in step S10 has arrived. There is no limitation on this timing, and as an example, it may be a timing of every predetermined amount of time (e.g., 30 seconds), or a timing according to the game status (e.g., the timing when a single match has ended). If the determination result from step S14 is affirmative, the process of step S15 is executed. On the other hand, if the determination result from step S14 is negative, the process of step S16 is executed.

In step S15, the CPU resets the excluded guest devices at the current point in time. That is, the contents of the excluded guest data stored in the memory are reset, and the excluded guest devices are set to a state where there is no excluded guest device. The process of step S16 is executed, following step S15.

As described above, in the present embodiment, the excluded guest devices are reset at the timing of step S14, but in other embodiments, the reset may be performed at any timing. For example, in other embodiments, when the delay amount calculated based on the operation data received from the excluded guest devices does not exceed the tolerance value, the host device may reset the exclusion of these guest devices.

In step S16, the CPU determines whether or not operation data has been selected in step S13 for the information processing devices except for the excluded guest devices. If the determination result from step S16 is affirmative, the process of step S17 is executed. On the other hand, if the determination result from step S16 is negative, the process of step S18 is executed.

In step S17, the CPU executes game process using the operation data selected in step S13. There is no limitation on the specific contents of the game process, and for example, the action of the player character may be controlled based on the selected operation data, or commands in the game may be selected based on the selected operation data. The process of step S19 is executed, following step S17.

On the other hand, in step S18, the CPU executes game process without using operation data. For example, the CPU controls the actions of non-player characters that are not controlled by the user according to predetermined rules, and performs an action control for the player character that is independent of user inputs (e.g., controlling the action of falling according to gravity). The process of step S19 is executed, following step S18. Note that in step S18, the process of waiting until operation data have been gathered may be performed, instead of performing the game process based on operation data, while performing processes that are not directly related to the progress of the game and that would be inconvenient if stopped, such as playing the BGM. This can be determined appropriately depending on the contents of the game.

Note that in other embodiments, in a configuration with multiple guest devices, if operation data of some of the guest devices that are not excluded guest devices are not selected in the process of step S13, the CPU may execute the game process using only the operation data selected in the step S18. For example, the CPU may control the action based on the selected operation data only for player characters corresponding to the guest devices whose operation data have been selected.

In step S19, the CPU increments the frame number. That is, the frame number data stored in the memory is updated to indicate a value obtained by adding 1 to the value before the update. The process of step S20 is executed, following step S19.

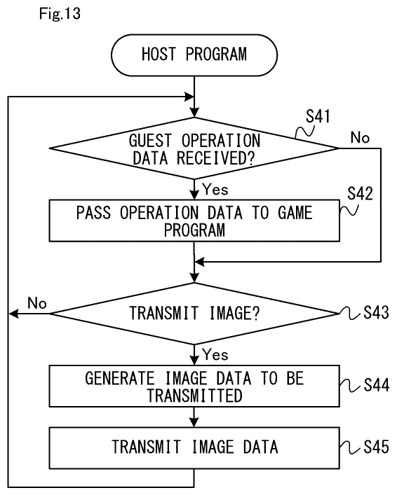

In step S20, the CPU issues an instruction to the GPU to generate a game image based on the result of the game process in step S16. Specifically, the CPU passes the graphics parameters used for the rendering process and the current frame number to the GPU. In response to this, the GPU executes the process of rendering the game image, thereby generating the game image (see FIG. 13). In other embodiments, the game image may be generated in a memory area different from the frame buffer and then rendered in the frame buffer. Note that, as described above, the GPU generates the game image for the guest devices as needed in addition to the game image for the host device. In the present embodiment, the game image for the guest devices is rendered in an area of the frame buffer in the host device that is different from the area for rendering the game image for the host device. The game image for the guest devices may also be generated in a memory area different from the frame buffer and then transmitted to the guest devices. The process of step S21 is executed, following step S20.

In step S21, the CPU determines whether the current frame is a frame to transmit the game image to the guest devices. In the present embodiment, the CPU determines that every second frame is a frame to transmit the game image to the guest devices. Note that when there are multiple guest devices, the host device does not need to transmit the game image to all the guest devices in the same frame. For example, when there are two guest devices, the host device may transmit the game image to the first guest device in odd-numbered frames and transmit the game image to the second guest device in even-numbered frames. If the determination result from step S21 is affirmative, the process of step S22 is executed. On the other hand, if the determination result from step S21 is negative, the process of step S23 is executed.

In step S22, the CPU gives an instruction to the host program to send the game image generated in step S20 to the guest devices. The process of step S23 is executed, following step S22. Note that the process of step S22 may be omitted. In that case, the host program to be described below performs, in step S43, the process of acquiring and transmitting the game image for the guest devices rendered on the frame buffer at a predetermined cycle (a cycle of 1/30 seconds in the present embodiment) or each time a new image is rendered on the frame buffer.

In step S23, the CPU determines whether or not to end the game being played by the game process in step S16. The CPU determines to end the game if a predetermined ending condition in the game is satisfied, or if the user gives an instruction to end the game, for example. If the determination result from step S23 is negative, the process of step S5 is executed again. In this case, the process of steps S5 to S23 is repeated until the game ends. On the other hand, if the determination result from step S23 is affirmative, the process of step S3 is executed again. In this case, a new game is started. Note that in this case, the CPU may, for example, return to the process of step S1 and re-determine the communication method, or return to the process of step S2 and re-determine the communication partner. Also in this case, the CPU may end the execution of the game program.

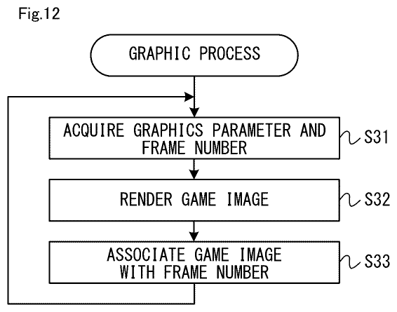

FIG. 12 is a flow chart showing an example of a flow of a graphic process executed by the system software on the GPU of the host device 2. The process shown in FIG. 12 is started in response to the start of the process shown in FIG. 10 and FIG. 11, for example. Note that in the example shown in FIG. 12, the process loop including the series of processes S31 to S33 is executed once per frame.

In step S31 shown in FIG. 12, the GPU acquires the graphics parameters sent from the CPU by the process of step S20 and the current frame number. The process of step S32 is executed, following step S31.

In step S32, the GPU renders the game image based on the graphics parameters acquired in step S31. That is, the GPU renders the data of the game image generated based on the graphics parameters to the frame buffer. Note that the game image for the host device is rendered in the first frame buffer, and the image rendered in the first frame buffer is displayed on the display 13 of the host device 2 at the image switching timing by the main body function (e.g., system software and/or firmware, etc.) of the host device 2. When generating the game images for the guest devices in addition to the game image for the host device, the GPU renders the game image for the guest devices in the second frame buffer, and the image rendered in the second frame buffer is transmitted to the guest devices. The process of step S33 is executed, following step S32.

In step S33, the GPU associates the frame number acquired in step S31 with the game image generated in step S32. Specifically, the GPU writes the information of the frame number into the metadata area of the image data. The process of step S31 is executed again, following step S33.

FIG. 13 is a flow chart showing an example of a flow of the information process executed by the host program on the CPU of the host device 2. The process shown in FIG. 13 is started in response to the start of the process shown in FIG. 10 and FIG. 11, for example. Note that in the example shown in FIG. 12, the process loop including the series of processes of steps S41 to S45 is executed every 1/60 [sec] in the present embodiment.

In step S41 shown in FIG. 13, the CPU determines whether or not operation data from a guest device has been received by the communication module 14. If the determination result from step S41 is affirmative, the process of step S42 is executed. On the other hand, if the determination result from step S41 is negative, the process of step S43 is executed.

In step S42, the CPU passes the received operation data to the game program. Specifically, the operation data associated with the frame number and operation number is passed to the operation data accumulation section 27, and the frame number and operation number are extracted and passed to the delay countermeasure process section 29. The process of step S43 is executed, following step S42.

In step S43, the CPU determines whether or not to transmit the game image to the guest device. That is, the CPU determines whether or not transmission of the game image has been instructed in step S22. If the determination result from step S43 is affirmative, the process of step S44. On the other hand, if the determination result from step S43 is negative, the process of step S41 is executed again.

In step S44, the CPU generates image data to be transmitted to the guest device. In the present embodiment, image data to be transmitted is generated by executing a resolution reduction process and an encoding process on the game image generated in step S32. Specifically, the CPU extracts the frame number from the image data associated with the frame number generated in step S33, and executes the process of reducing the resolution of the image data. Next, the CPU encodes the image data whose resolution has been reduced and writes the frame number into the metadata area of the encoded image data. The process of step S45 is executed, following step S44.

In step S45, the CPU transmits the image data to be transmitted generated in step S44 to the guest device using the communication module 14. At this time, the CPU identifies the recipient guest device by referring to the communication partner data stored in the memory. Thus, in the present embodiment, the management of the communication partner determined in step S2 is performed on the system software side. Therefore, on the game program side, there is no need to identify the recipient guest device in the transmission instruction in step S22, for example, thereby improving the efficiency in developing game programs. The process of step S41 is executed again, following step S45.

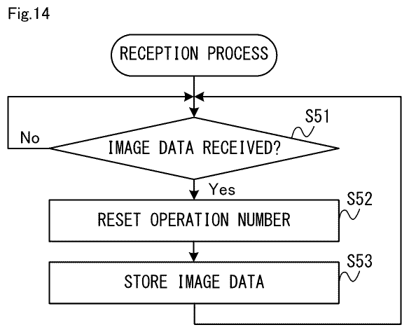

FIG. 14 is a flow chart showing an example of a flow of a reception process executed by the guest program on the CPU of the guest device 3. The process shown in FIG. 14 is started, for example, in response to the communication partner of the host device (i.e., the guest device) being determined by the process of step S2 shown in FIG. 10 and communication between the host device and the guest device being started. At this time, the CPU stores, in the memory, data indicating the ID of the host device to be the communication partner as communication partner data.

In step S51 shown in FIG. 14, the CPU determines whether or not image data from the host device 2 (i.e., the image data transmitted in step S45) has been received by the communication module. If the determination result from step S51 is affirmative, the process of step S52 is executed. On the other hand, if the determination result from step S51 is negative, the process of step S54 is executed.

In step S52, the CPU resets the operation number to be counted. Specifically, the CPU stores data indicating 0 in the memory as the operation number data. The process of step S53 is executed, following step S52.

In step S53, the CPU decodes the image data received in step S51 and stores the decoded image data in the memory. The process of step S51 is executed again, following step S53. Thereafter, the process of steps S51 to S53 is executed repeatedly.

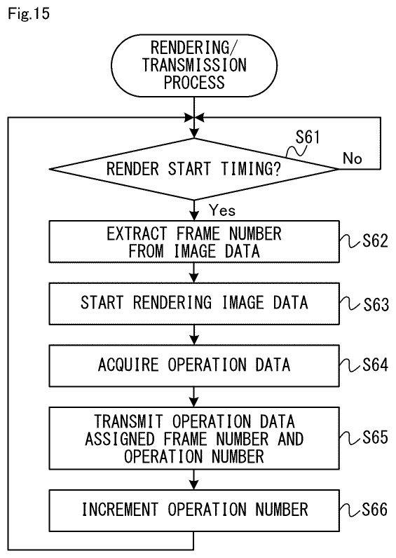

FIG. 15 is a flow chart showing an example of a flow of the rendering/transmitting process executed by the guest program on the CPU of the guest device 3. The process shown in FIG. 15 is started in the same manner as the process shown in FIG. 14, for example, in response to the communication partner of the host device being determined by the process of step S2 shown in FIG. 10 and communication between the host device and the guest device being started. In the guest device, the process shown in FIG. 15 is executed in parallel with the process shown in FIG. 14.

In step S61, the CPU determines whether or not the timing for starting rendering in the current frame has arrived. As described above, in the present embodiment, this timing is a timing that is a predetermined amount of time before the end timing of one frame period (see FIG. 7). If the determination result from step S61 is affirmative, the process of step S62 is executed. On the other hand, if the determination result from step S61 is negative, the process of step S61 is executed again. The determination result from step S61 becomes affirmative once in one frame period, and as a result, the process of steps S62 to S66 to be described below is executed in a cycle of 1/60 [sec]. Therefore, in the present embodiment, the image data rendering process and the operation data acquisition process are performed every 1/60 [sec].

In step S62, the CPU extracts the frame number embedded in the image data from the image data last stored by the process of step S53 described above. The process of step S63 is executed, following step S62.

In step S63, the CPU starts rendering the image data from which the frame number has been extracted in step S62. That is, the CPU instructs the GPU to execute the rendering process (specifically, writing the received image data to the frame buffer) for the image data. Thus, the rendering process is started, and the rendering process is completed in the current frame period. The process of step S64 is executed, following step S63.

In step S64, the CPU acquires the operation data of the host device. The process of step S65 is executed, following step S64.

In step S65, the CPU transmits the operation data to the host device 2 while the operation data is associated with the frame number and operation number. Specifically, the CPU associates the operation data acquired in step S64 with the frame number extracted in step S62 and the operation number indicated by the operation number data stored in the memory. Next, the CPU transmits the operation data associated with the frame number and operation number to the host device 2 using the communication module. The process of step S66 is executed, following step S65.

In step S66, the CPU increments the operation number. That is, the operation number data stored in the memory is updated to indicate a value obtained by adding 1 to the value before the update. The process of step S61 is executed again, following step S66.

### [4. Variations of Present Embodiment]

In the embodiment described above, information indicating the frame number assigned to the frame in which the game image is generated is used as the timing information used for the delay countermeasure process, but there is no limitation on the specific contents of the timing information. In other embodiments, for example, information indicating the time (e.g., timestamp) may be used as the timing information. The current timing information at the host device may be information that can be acquired at the host device regardless of whether the time is synchronized between the host device, the guest devices, the servers, etc., and may be information indicating the timing of the game image generated at the host device.

As the delay countermeasure process, in the embodiment described above, the host device calculates the delay amount, and executes process to select the operation data of the host device and the guest device used for the game process based on the delay amount. Here, there is no limitation on the contents of the process executed based on the delay amount for delay countermeasure, and the contents of the process are not limited to the above. For example, using the delay amount calculated by the process of the present embodiment, it is possible to use any delay countermeasure technology, such as the delay countermeasure technology disclosed in Japanese Laid-Open Patent Publication No. 2022-160999, Japanese Laid-Open Patent Publication No. 2022-161009, Japanese Laid-Open Patent Publication No. 2022-161000, and Japanese Patent Registration No. 6927750. For example, in other embodiments, the host device may select, based on the delay amount, only the operation data of the host device used for the game process. In this case, the operation data of the guest device may be selected based on a rule independent of the delay amount (e.g., a rule in which the last received data at the host device is selected). According to the above, data that has been acquired in the past is selected in consideration of the delay amount, instead of the latest operation data of the host device (i.e., the one that is acquired in the current frame), thereby preventing it from being too advantageous for the host device in the game.

There is no limitation on the specific contents of the delay countermeasure process, and the specific contents are not limited to the process of calculating the delay amount. For example, in other embodiments, the host device may execute the process of selecting operation data used for the game process based on timing information associated with the operation data without calculating the delay amount as the delay countermeasure process. Specifically, the host device may select a set of operation data associated with timing information of equivalent timing from among the operation data of the host device and the operation data of the guest device that have been accumulated. Note that “a set of operation data associated with timing information of equivalent timing” as used in the embodiment described above refers to a set of operation data associated with frame numbers of the same value or with frame numbers whose difference is within a predetermined range. This also reduces the possibility of creating advantages/disadvantages in the game between the host device and the guest devices.

When a delay amount is used in the delay countermeasure process, the delay amount does not need to be based on the frame number as in the embodiment described above. For example, in other embodiments, the host device 2 may calculate the delay amount in advance before the start of the game by a method different from the method using the frame number, and may perform the delay countermeasure process, during the game, using the delay amount calculated in advance.

While the information processing system of the embodiment described above executes the delay countermeasure process based on timing information, the information processing system does not necessarily need to execute such a delay countermeasure process. The information processing system may take countermeasures against communication delays by other processes different from the delay countermeasure process, or may solve problems different from communication delays.

With the information processing system of the embodiment described above, the second cycle for rendering the game image on the guest device is made shorter than the first cycle for transmitting the game image from the host device to the guest device, but there is no limitation on the length relationship between the first cycle and the second cycle. In other embodiments, the second cycle may be the same length as the first cycle or longer than the first cycle.

In the information processing system of the embodiment described above, the timing for starting rendering on the guest device is set to a timing that is a predetermined amount of time before the timing for switching the game image to be displayed. According to this, regardless of the relationship between the first cycle and the second cycle, the timing at which the game image is displayed on the guest device can be made earlier, thus realizing countermeasures against delay. Note that there is no limitation on the timing for starting rendering. In other embodiments, the timing to start rendering may be different from a timing that is a predetermined amount of time before the timing for switching the game image, and may be earlier than this timing.

In other embodiments, the host device does not need to be configured to display the game image thereon as in the embodiment described above, and the game image does not need to be displayed on the host device. That is, the host device may be configured to generate only the game image for the guest device.

In the embodiment described above, the game program is a program for a game executed using multiple information processing devices, but there is no limitation on the contents of the game. The game may be a multiplayer game in which multiple users play the game using information processing devices respectively, or a single-player game in which a single user plays the game using multiple information processing devices (e.g., by looking at multiple displays).

Note that in other embodiments, the information processing system does not need to include some of the components of the embodiment described above and does not need to execute some of the processes that are executed in the embodiment described above.

In the present embodiment, a program means to include source code, intermediate code, object code, native code, scripts, etc., and there is no limitation on the form of the code. A program does not only mean the entirety of an application program, but may also include a program that realizes some of the functions of an application. Furthermore, the functions of the present embodiment may be realized by multiple programs separated from each other. In this case, the collection of multiple programs can also be said to be a program. The program causes a computer composed of a main processor, a subprocessor, peripheral circuits, firmware, etc. in an information processing device to function so as to realize the functions of the present embodiment. A single processor may execute the program, or different processors may execute different functions of the program. The functions realized by the program does not need to be realized solely by the process of the processor, but may be realized by using functions included in the computer (e.g., functions such as graphics or wireless communication). Furthermore, the computer may be implemented by an interpreter or an emulator, in which case the program may be a program that can run on the interpreter or the emulator.

The embodiment described above can be used in a game system or a game program, for example, with the aim of enabling novel countermeasures against communication delays, for example.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. An information processing system, comprising a host device and one or more guest device capable of communicating with the host device, wherein:
the host device comprises:
one or more memories storing a first set of instructions; and
one or more processors that execute the first set of instructions;
the one or more processors and the first set of instructions are configured to collaboratively perform a first set of operations comprising:
receiving, from the guest device, first operation data indicating an operation on the guest device;
executing a game process based on the first operation data;
generating a game image indicating results of the game process; and
transmitting the generated game image to the guest device;
the guest device comprises:
one or more memories storing a second set of instructions; and
one or more processors that execute the second set of instructions;
the one or more processors and the second set of instructions are configured to collaboratively perform a second set of operations comprising:
receiving the game image transmitted from the host device;
starting a process of rendering the received game image at a timing that is an amount of time before or after a timing for switching display of the game image;
acquiring the first operation data; and
transmitting the first operation data to the host device.

2. The information processing system according to claim 1, wherein:
the first set of operations further comprises:
acquiring second operation data indicating an operation on the host device;
executing the game process based on the first operation data and the second operation data;
outputting the game image indicating the results of the game process on a display device of the host device.

3. The information processing system according to claim 2, wherein:
the timing to start rendering the game image is a predetermined amount of time before the display switching timing; and
the predetermined amount of time is an amount of time determined in consideration of an amount of time required for rendering the game image.

4. The information processing system according to claim 1, wherein:
the first set of instructions is configured to be included in a game program for the game process or system software different from the game program;
the system software includes:
an instruction to, when receiving the generated game image from the game program, perform the transmission of the generated game image to the guest device; and
an instruction to perform the receiving the second operation data from the guest device to pass the second operation data to the game program.

5. The information processing system according to claim 1, wherein:
the first set of operations further comprises:
reducing a resolution of the generated game image; and
transmitting the game image whose resolution has been reduced to the guest device.

6. The information processing system according to claim 1, wherein:
the first set of operations further comprises:
starting rendering the game image at a timing for switching the game image to be displayed on the host device.

7. The information processing system according to claim 1, wherein the timing for switching the game image to be displayed on the host device and the timing for switching the game image to be displayed on the guest device are independent of each other.

8. One or more non-transitory computer-readable medium having stored therein instructions that, when executed, cause a game device to perform operations comprising:
receiving a game image transmitted from another information processing device; and
starting rendering the received game image at a timing that is an amount of time before or after a timing for switching display of the game image.

9. The storage medium according to claim 8, wherein:
the timing to start rendering the game image is a predetermined amount of time before the display switching timing; and
the predetermined amount of time is an amount of time determined in consideration of an amount of time required for rendering the game image.

10. The storage medium according to claim 8, wherein the display switching timing is independent of the display switching timing of the other information processing device.

11. An information processing method to be executed on an information processing system including a host device and one or more guest device capable of communicating with the host device, wherein:
the host device receives, from the guest device, first operation data indicating an operation on the guest device;
the host device executes a game process based on the first operation data;
the host device generates a game image indicating results of the game process;
the host device transmits the generated game image to the guest device in a first cycle;
the guest device receives the game image transmitted from the host device in the first cycle;
the guest device renders the received game image in a second cycle shorter than the first cycle;
the guest device acquires the first operation data; and
the guest device transmits the first operation data to the host device.

12. The information processing method according to claim 11, wherein:
the host device is configured to:
acquire second operation data indicating an operation on the host device;
execute the game process in the second cycle based on the first operation data and the second operation data;
generate a game image indicating results of the game process in the second cycle; and
output the game image generated in the second cycle to a display device of the host device.

13. The information processing method according to claim 11, wherein the guest device starts rendering the game image at a timing that is a predetermined amount of time before a timing for switching the game image to be displayed.

14. The information processing method according to claim 11, wherein the predetermined amount of time is an amount of time required for the guest device to render the game image.
